(19) United States
(12) Patent Application Publication
(10) Pub. No.: US 2026/0322632 A1
(43) Pub. Date: Oct. 15, 2026

(54) A SYSTEM AND A METHOD FOR A CONSENSUS MECHANISM IN A BLOCK CHAIN NETWORK

(71) Applicant: Sachin KUMAR, Greater Noida (IN)

(72) Inventors: Sachin KUMAR, Greater Noida (IN); Vaibhav TRIPATHI, GREATER NOIDA (IN); Jyotika SINGHAL, GREATER NOIDA (IN); Vijay KUMAR, GREATER NOIDA (IN)

(21) Appl. No.: 19/483,624

(22) PCT Filed: Jul. 21, 2023
(86) PCT No.: PCT/IB2023/057453

§ 371 Date: Nov. 12, 2025

(30) Foreign Application Priority Data
May 12, 2023 (IN) 202311033716

(51) Int. Cl. H04L 9/00

(52) U.S. Cl. CPC H04L 9/50; H04L 9/002

(57) ABSTRACT

A system (100) to enable a consensus mechanism in a blockchain network is disclosed. The system includes a receiving module (112) to receive data for processing from a contract layer and an agent (128). The system also includes a plurality of nodes (114) to assign a weight to each parameter of a plurality of first parameters to obtain a validator node. The system includes a plurality of modules to calculate corresponding parameters namely, stakes, uptime, capacity, sustainability score and node utilization. Weightage is assigned to the corresponding parameters. The system includes a validator node selection module (126) to calculate a cumulative score for each node and subsequently select the validator nodes to be added to the block chain network.

This application claims priority from a Complete patent application filed in India having patent application No. 202311033716, filed on May 12, 2023, and titled “A SYSTEM AND A METHOD FOR A CONSENSUS MECHANISM IN A BLOCK CHAIN NETWORK”.

### FIELD OF INVENTION

Embodiments of the present disclosure relate to a field of block chains and more particularly to a system and method for a consensus mechanism in a block chain network.

### BACKGROUND

Blockchain technology is evolving at a high pace given the increased use cases in various industries. A third generation blockchain enables the users to build a scalable and interoperable ecosystem. The blockchain technology has evolved past simple peer to peer transactions. Innovations have led to decentralized applications (DApps) being built on top of the blockchain and scalability has become an increasing challenge with the growth of data on blockchains. The core of any block chain is the consensus mechanism that influences how the transactions are verified and corresponding blocks created. However, the existing consensus mechanisms fail to meet the requirements of the current evolution of blockchain technology.

Multiple consensus protocols have been developed particularly after the origination of Bitcoin's Proof of Work. However, a single consensus protocol fails to meet the complex security and requirements of the new age DApps and transactions. Specifically, the existing Proof-of-Work (PoW) and Proof-of-Stake (POS) have several drawbacks. The PoW protocol involves complex problem-solving to process a block thus requiring high energy. Further, a large infrastructure is required for both PoW and PoS and is not sustainable for every validator. Moreover, as nodes with higher stakes are prioritized for consensus, issues such as cartelization have increased. This also leads to security concerns.

Hence, there is a need for an improved system and a method for a consensus mechanism in a blockchain network to address the aforementioned issue(s).

### OBJECTIVE OF THE INVENTION

An objective of the invention includes providing a system and a method for consensus mechanism in a block chain network.

### BRIEF DESCRIPTION

In accordance with an embodiment of the present disclosure, a system for consensus mechanism in a block chain network is provided. The system includes a processing subsystem hosted on a server. The processing subsystem is configured to execute on a network to control bidirectional communications among a plurality of modules. The processing subsystem includes a receiving module configured to receive data for processing from a contract layer and an agent. The processing subsystem also includes a plurality of nodes operatively connected to the receiving module and configured to assign a weight to each parameter of a plurality of first parameters to obtain a validator node. The plurality of parameters is configured to be validated by a blockchain through the agent deployed on a node of the plurality of nodes before selecting the plurality of parameters to be a part of a consensus. The processing subsystem includes a stake parameter calculation module operatively coupled to the plurality of nodes and configured to calculate the proof of stake by calculating a stake coefficient of a node of the plurality of nodes, wherein the stake coefficient is obtained by dividing the stake of one of the nodes of the plurality of nodes by a total stake of nodes. The processing subsystem includes an uptime calculation module operatively coupled with the stake parameter calculation module configured to limit the ability of the validator node to take part in transaction validation to a specified time period and calculate the uptime of a node, wherein the calculated uptime score of one of the nodes is configured with a lower bound. The processing subsystem includes a capacity calculation module operatively coupled with the uptime calculation module and configured to calculate the capacity of a machine to become a validator node by aggregating a plurality of second parameters, wherein the plurality of second parameters includes a hard disk score, random access memory score and a processor core score. Further, the processing subsystem includes a sustainability score module operatively coupled with the capacity calculation module and configured to assign a static sustainability score to each validator node based on a plurality of third parameters at the time of selection. Furthermore, the processing subsystem includes a node utilization module configured to calculate a node utilization for each validator node based on an uptime parameter wherein by subtracting blocks of the blockchain verified from the last calculated uptime and dividing the result by hundred. Moreover, the processing subsystem includes a validator node selection module operatively coupled with the node utilization module and configured to calculate the plurality of first parameters for each node, randomly select the validator nodes and add the calculated plurality of first parameters by dividing the plurality of first parameters and a plurality of second parameters by one hundred to get the final score for each node of the plurality of nodes. The validator node selection module is also configured to select a plurality of nodes as the validator nodes base based on the final score at pre-defined time intervals and add a transaction to the selected plurality of nodes upon implementing Byzantine Fault Tolerance.

In accordance with another embodiment of the present disclosure, a method for consensus mechanism in a block chain network is provided. The method includes receiving, by a receiving module of a processing subsystem, data for processing from a contract layer and an agent. The method also includes assigning a weight, by a plurality of nodes, to each parameter of a plurality of first parameters to obtain a validator node wherein the plurality of parameters is configured to be validated by a blockchain through the agent deployed on a node of the plurality of nodes before selecting the plurality of parameters to be a part of a consensus. The method includes calculating, by a stake parameter calculation module, the proof of stake by calculating a stake coefficient of a node of the plurality of nodes, wherein the stake coefficient is obtained by dividing the stake of one of the nodes of the plurality of nodes by a total stake of nodes. The method includes limiting, by an uptime calculation module, the ability of the validator node to take part in transaction validation to a specified time period. The method includes calculating, by the uptime calculation module, the uptime of a node, wherein the calculated uptime score of one of the nodes is configured with a lower bound. The method includes calculating, by a capacity calculation module, the capacity of a machine to become a validator node by aggregating a plurality of second parameters, wherein the plurality of second parameters includes a hard disk score, random access memory score and a processor core score. The method includes assigning, by a sustainability score module, a static sustainability score to each validator node based on a plurality of third parameters at the time of selection. The method includes calculating, by a node utilization module, a node utilization for each validator node based on an uptime parameter wherein by subtracting blocks of the blockchain verified from the last calculated uptime and dividing the result by hundred. The method includes calculating, by a validator node selection module, the plurality of first parameters for each node. The method includes randomly selecting, by the validator node selection module, the validator nodes. Further, the method includes adding, by the validator node selection module, the calculated plurality of first parameters by dividing the plurality of first parameters and a plurality of second parameters by one hundred to get the final score for each node of the plurality of nodes.

Furthermore, the method includes selecting, by the validator node selection module, a plurality of nodes as the validator nodes base based on the final score at pre-defined time intervals. Moreover, the method includes adding, by the validator node selection module, a transaction to the selected plurality of nodes upon implementing Byzantine Fault Tolerance.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for consensus mechanism in a block chain network in accordance with an embodiment of the present disclosure;

FIG. 2 is a schematic representation of a plurality of parameters for selecting validator nodes of one embodiment of the system of FIG. 1, in accordance with an embodiment of the present disclosure;

FIG. 3 is an exemplary flow chart illustrating a validation node selection of the system of FIG. 1, in accordance with an embodiment of the present disclosure;

FIG. 4 is a block diagram of a computer or a server in accordance with an embodiment of the present disclosure;

FIG. 5(a) is a flow chart representing the steps involved in a method for consensus mechanism in a block chain network in accordance with an embodiment of the present disclosure;

FIG. 5(b) is the continued steps involved in the method for consensus mechanism in a block chain network in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for consensus mechanism in a block chain network. The system includes a processing subsystem hosted on a server and configured to execute on a network to control bidirectional communications among a plurality of modules. The processing subsystem includes a receiving module configured to receive data for processing from a contract layer and an agent. The processing subsystem also includes a plurality of nodes operatively connected to the receiving module and configured to assign a weight to each parameter of a plurality of first parameters to obtain a validator node. The plurality of parameters is configured to be validated by a blockchain through the agent deployed on a node of the plurality of nodes before selecting the plurality of parameters to be a part of a consensus. The processing subsystem includes a stake parameter calculation module operatively coupled to the plurality of nodes and configured to calculate the proof of stake by calculating a stake coefficient of a node of the plurality of nodes, wherein the stake coefficient is obtained by dividing the stake of one of the nodes of the plurality of nodes by a total stake of nodes. The processing subsystem includes an uptime calculation module operatively coupled with the stake parameter calculation module configured to limit the ability of the validator node to take part in transaction validation to a specified time period and calculate the uptime of a node, wherein the calculated uptime score of one of the nodes is configured with a lower bound. The processing subsystem includes a capacity calculation module operatively coupled with the uptime calculation module and configured to calculate the capacity of a machine to become a validator node by aggregating a plurality of second parameters, wherein the plurality of second parameters includes a hard disk score, random access memory score and a processor core score. Further, the processing subsystem includes a sustainability score module operatively coupled with the capacity calculation module and configured to assign a static sustainability score to each validator node based on a plurality of third parameters at the time of selection. Furthermore, the processing subsystem includes a node utilization module configured to calculate a node utilization for each validator node based on an uptime parameter wherein by subtracting blocks of the blockchain verified from the last calculated uptime and dividing the result by hundred. Moreover, the processing subsystem includes a validator node selection module operatively coupled with the node utilization module and configured to calculate the plurality of first parameters for each node, randomly select the validator nodes and add the calculated plurality of first parameters by dividing the plurality of first parameters and a plurality of second parameters by one hundred to get the final score for each node of the plurality of nodes. The validator node selection module is also configured to select a plurality of nodes as the validator nodes base based on the final score at pre-defined time intervals and add a transaction to the selected plurality of nodes upon implementing Byzantine Fault Tolerance.

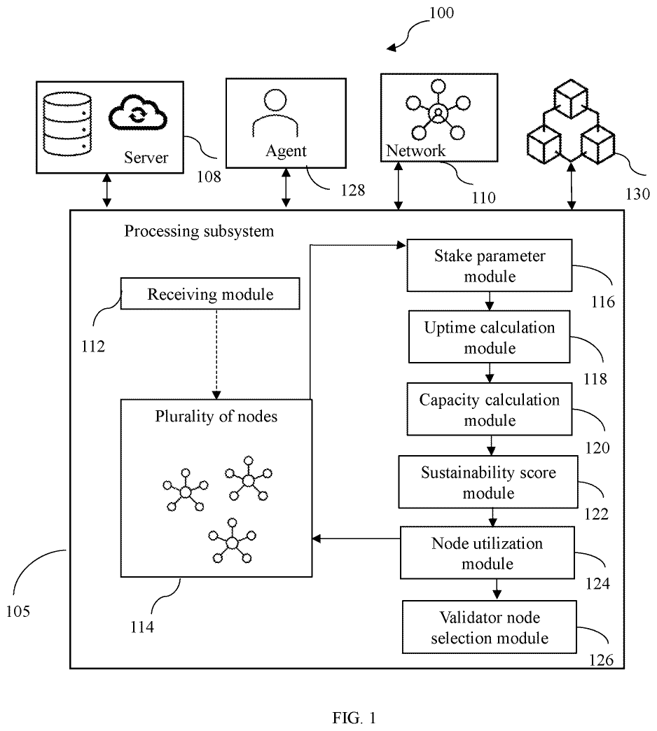

FIG. 1 is a block diagram representing a system (100) for consensus mechanism in a blockchain (130) in accordance with an embodiment of the present disclosure. The system (100) includes a processing subsystem (105). The processing subsystem (105) is hosted on a server (108) and configured to execute on a network (110) to enable communications among a plurality of modules. In one embodiment, the server (108) may include a cloud server. In another embodiment, the server (108) may include a local server. In one embodiment, the network (110) may include a wired network such as a local area network (LAN). In another embodiment, the network technologies may include a wireless network such as Wi-Fi, Bluetooth, Zigbee, near field communication (NFC), infra-red communication (RFID), and the like. The plurality of modules includes a receiving module (112), a plurality of nodes (114), a stake parameter calculation module (116), an uptime calculation module (118), a capacity calculation module (120), a sustainability score module (122), a node utilization module (124), and a validator node selection module (126).

The receiving module (112) is configured to receive data for processing from a contract layer and an agent (128). In one embodiment, the agent (128) may be deployed on the node of the plurality of nodes (114) before selecting the agent (128) to be a part of the consensus. In another embodiment, each agent (128) is unique and cannot be copied.

The plurality of nodes (114) is operatively connected to the receiving module (112) and configured to assign a weight to each parameter of a plurality of first parameters to obtain a validator node. The plurality of parameters is configured to be validated by a blockchain (130) through the agent (128).

The stake parameter calculation module (116) is operatively coupled to the plurality of nodes (114) and configured to calculate the proof of stake by calculating a stake coefficient of a node of the plurality of nodes. The stake coefficient is obtained by dividing the stake of one of the nodes of the plurality of nodes (114) by a total stake of nodes. In one embodiment, the stake parameter may be holdings of the node of the plurality of nodes.

Typically, the nodes must stake for a specific locking period to become a validator node. An owner will have to provide proof of stakes and will be identified on the below calculation:
Let stake of ith node is defined by Si
Total stake of nodes is defined by:

$$TS = {\sum }_{i = 1}^{N} Si$$

Stake coefficient of node is defined by:

$$SCi = \frac{Si}{TS} = \frac{Si}{{\sum }_{i = 1}^{N} Si}$$

The uptime calculation module (118) is operatively coupled with the stake parameter calculation module (116). The uptime calculation module (118) is configured to limit the ability of the validator node to take part in transaction validation to a specified time period. In other words, the uptime parameter ensures that there is no monopoly of a single node, and that the selection of validator nodes is random. Moreover, it is made sure that no validator node participates in the transaction for a pre-defined time period. This is to ensure that any node with high stakes or capacity or sustainability scope does not monopolize the validation mechanism and ensures reduced cartelization. Therefore, each node will ‘sleep’ after the said pre-defined time period of uptime (randomly generated).

The uptime calculation module (118) is also configured to calculate the uptime of a node, wherein the calculated uptime score of one of the nodes is configured with a lower bound. In one embodiment, the uptime may be idle time of a node of the plurality of nodes (114). In another embodiment, the uptime parameter may be subjective to the node performance.

The uptime score is calculated as follows:

Let uptime score of ith node be defined as UTi.

UTi computed as (ζ—running time in mins)/ζ where UTi has a lower bound of 0 i.e., at any point of time UTi≥0

The capacity calculation module (120) is operatively coupled with the uptime calculation module (118) and configured to calculate the capacity of a machine to become a validator node by aggregating a plurality of second parameters, wherein the plurality of second parameters includes a hard disk score, random access memory score and a processor core score. Typically, each of the validator nodes will need to declare and validate the plurality of second parameters at the time of registration. The plurality of second parameters is validated constantly by the blockchain (130) through an agent (128) deployed on each corresponding node before selecting the node to be a part of the consensus. In one embodiment, the capacity calculation module (120) may be a storage capacity of a node of the plurality of nodes.

The total capacity score of the node based on above weightage is calculated as below:

Capacity score of the Node CSi=HDSi X η/100+RSi×θ/100+PCSi X ι1/100
Where η is the hard disk score (HDS),
↓ is the Ram Score (RS) and
ι is the Processor Core Score (PCS).

The sustainability score module (122) is operatively coupled with the capacity calculation module (120) and is configured to assign a static sustainability score to each validator node based on a plurality of third parameters at the time of selection. In one embodiment, the plurality of third parameters includes environment, social, and governance, and the like. In one embodiment, a static sustainability score may be assigned to each validator at the time of selection of a node of the plurality of nodes. The sustainability score module (122) is calculated based on the following parameters:
a. Environmental: Energy Source, Carbon offset, recycling initiatives, compliance with environment regulations.
b. Social: Gender Diversity, Social Welfare, Transparency in reporting.
c. Governance: Transparent accounting methods, shareholder rights, anti-corruption.

The node utilization module (124) is configured to calculate a node utilization for each validator node based on an uptime parameter. By subtracting blocks of the blockchain (130) verified from the last calculated uptime and dividing the result by a hundred. In one embodiment, the calculated node utilization score may be assigned to the validators based on the validations done during the last uptime and accordingly, the weightage provided is reduced.

For every validator node trying to participate in the validation process, node utilization is calculated based on the number of blocks verified since the last uptime. The node utilization is calculated as follows:
Let utilization score of ith node be defined as USi
USi computed as (100−total blocks validated since last uptime)/100 where USi has a lower bound of 0 i.e., at any point of time USi≥0
Total Score=SCi X α/100+UTi X β/100+CSi X γ/100+SUSi X δ/100+USi X ε/100)

The validator node selection module (126) is operatively coupled with the node utilization module (124). The validator node selection module (126) is configured to calculate the plurality of the first parameters for each node and randomly select the validator nodes. The validator node selection module (126) is also configured to add the calculated plurality of first parameters by dividing the plurality of first parameters and a plurality of second parameters by one hundred to get the final score for each node of the plurality of nodes. Further, the validator node selection module (126) is configured to select a plurality of nodes (114) as the validator nodes base based on the final score at pre-defined time intervals. Furthermore, the validator node selection module (126) is configured to add a transaction to the selected plurality of nodes (114) upon implementing Byzantine Fault Tolerance. In one embodiment, Byzantine Fault Tolerance is the ability of the system to continue functioning even when some components are faulty or failed.

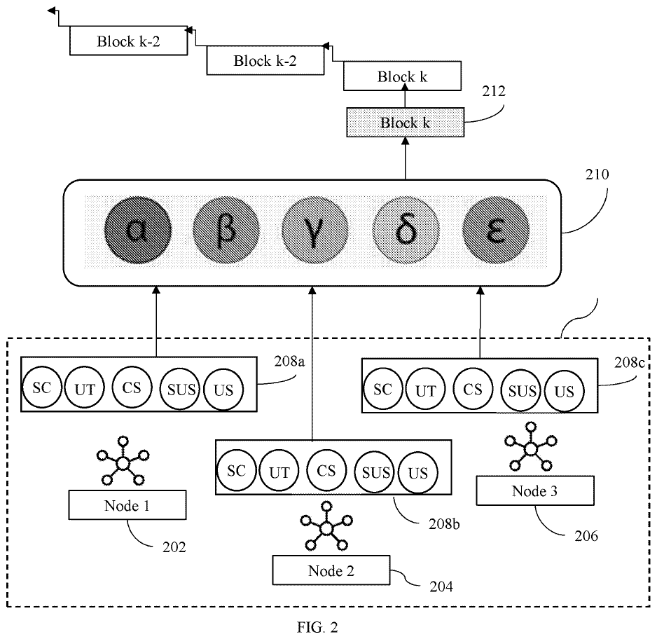

FIG. 2 is a schematic representation of a plurality of parameters for selecting a plurality of validator nodes of one embodiment of the system of FIG. 1, in accordance with an embodiment of the present disclosure. Consider Node 1 (202), Node 2 (204) and Node 3 (206). Each of the said nodes are assigned with a plurality of parameters (208a, 208b, 208c). Specifically, the plurality of parameters (208a, 208b, 208c) includes stakes (SC), uptime (UT), capacity (CS), sustainability score (SUS) and utilization (US). Each of the plurality of parameters are assigned a specific weightage (210). This implies that the node must cater to the said weightage in order to become a validator node. In one embodiment, the weightage can also be used to randomly select the validator nodes for each transaction. The following Table 1 illustrates the plurality of

TABLE 1
Parameters and its description with associated weightage

| Parameter | Description | Weightage |
|---|---|---|
| Stake | Holdings of the node | α |
| Uptime | Uptime/Idle time of node | β |
| Capacity | Compute or Storage capacity of | γ |
| Sustainability | Evaluate each node for ESG | δ |
| Score | compliance. Specific parameters to | |
| | be defined for evaluation. | |
| Node Utilization | Participation of node in | ε |
| | validation process | |

parameters along with their respective description and weightage.

Therefore, based on the above parameters, each node is assigned a cumulative weight. Subsequently, the top 29 nodes will be selected as validator nodes from a defined pool of validator nodes and these top 29 nodes are added in the blockchain, for instance Block k (212).

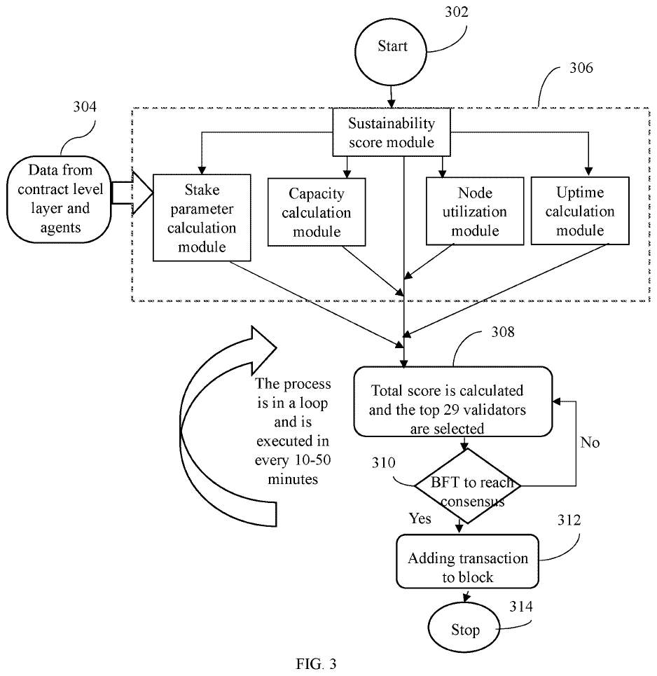

FIG. 3 is an exemplary flow chart illustrating a validation node selection of the system of FIG. 1, in accordance with an embodiment of the present disclosure. The flow chart starts at step (302). The validation node selection begins at the time of consensus. Realtime data is received from a contract level layer and agents deployed at each node in step (304). At this point, plurality of parameters namely, stakes, uptime, capacity, sustainability score and node utilization is calculated for each node at step (306). It must be noted that the combination of the said plurality of parameters ensures a higher grade of randomization for selecting the validator nodes. Further, each of the plurality of parameters are assigned a corresponding weightage. Subsequently, a total score is calculated based on the weightage at step (308). This process of calculating the total score for each of the nodes is repeated until a predefined number of validator nodes are selected. In a specific embodiment, the predefined number of validator nodes is the top 29 nodes. Further, the process is repeated at predefined time periods, for instance every 10-15 minutes. In one embodiment, the process is performed for every blockchain that requires validation.

Further, it must be noted that the process is automatically performed in real-time.

Once the predefined number of validator nodes are selected, the said validator nodes are sent to Byzantine fault tolerance (BFT) for an additional verification at step (310). This ensures that the selected predefined validator nodes are not faulty or have not failed. In the case that one or more validator nodes are faulty, then another validator node is selected as a replacement.

Upon successful selection of the validator nodes, the said validator nodes is added to the blockchain at step (312). The flow chart ends at step (314).

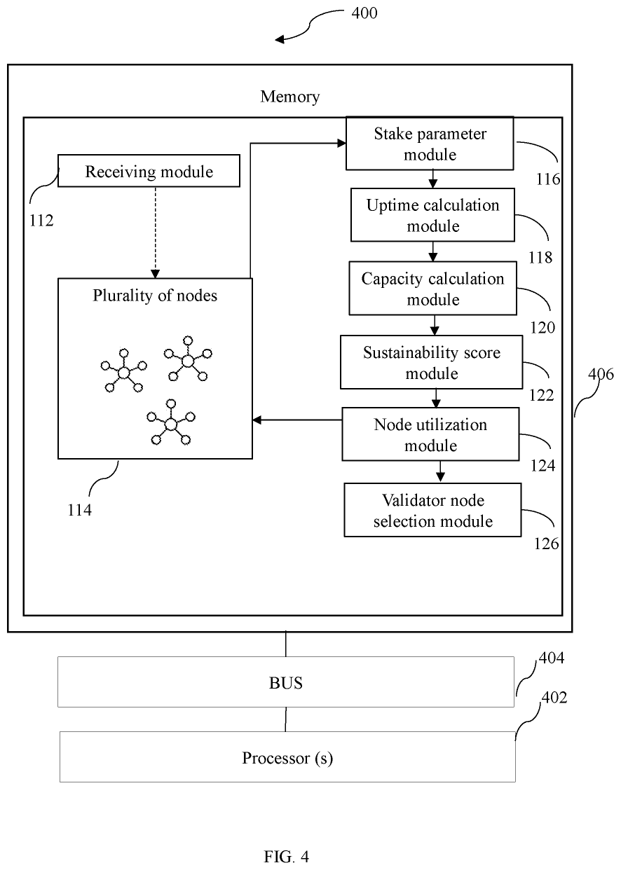

FIG. 4 is a block diagram of a computer or a server in accordance with an embodiment of the present disclosure. The server includes processor(s), and memory operatively coupled to the bus. The processor(s), as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory includes several subsystems stored in the form of executable program which instructs the processor to perform the method steps illustrated in FIG. 1. The memory is substantially similar to the system of FIG. 1. The memory has the following subsystems: the processing subsystem includes the receiving module, the plurality of nodes, the stake parameter module, the uptime calculation module (118), the capacity calculation module (120), the sustainability score module (122), the node utilization module (124) and the validator node selection module (126). The plurality of modules of the processing subsystem performs the functions as stated in FIG. 1. The bus used herein refers to be the internal memory channels or computer network that is used to connect computer components and transfer data between them. The bus includes a serial bus or a parallel bus, wherein the serial bus transmit data in bit-serial format and the parallel bus transmit data across multiple wires. The bus used herein may include but not limited to, a system bus, an internal bus, an external bus, an expansion bus, a frontside bus, a backside bus, and the like.

The processing subsystem includes a receiving module configured to receive data for processing from a contract layer and an agent. The processing subsystem also includes a plurality of nodes (114) operatively connected to the receiving module and configured to assign a weight to each parameter of a plurality of first parameters to obtain a validator node. The plurality of parameters is configured to be validated by a blockchain through the agent deployed on a node of the plurality of nodes (114) before selecting the plurality of parameters to be a part of a consensus. The processing subsystem includes a stake parameter calculation module (116) operatively coupled to the plurality of nodes (114) and configured to calculate the proof of stake by calculating a stake coefficient of a node of the plurality of nodes, wherein the stake coefficient is obtained by dividing the stake of one of the nodes of the plurality of nodes (114) by a total stake of nodes.

The processing subsystem includes an uptime calculation module (118) operatively coupled with the stake parameter calculation module (116) configured to limit the ability of the validator node to take part in transaction validation to a specified time period and calculate the uptime of a node, wherein the calculated uptime score of one of the nodes is configured with a lower bound. The processing subsystem includes a capacity calculation module (120) operatively coupled with the uptime calculation module (118) and configured to calculate the capacity of a machine to become a validator node by aggregating a plurality of second parameters, wherein the plurality of second parameters includes a hard disk score, random access memory score and a processor core score.

Further, the processing subsystem includes a sustainability score module (122) operatively coupled with the capacity calculation module (120) and configured to assign a static sustainability score to each validator node based on a plurality of third parameters at the time of selection. Furthermore, the processing subsystem includes a node utilization module (124) configured to calculate a node utilization for each validator node based on an uptime parameter wherein by subtracting blocks of the blockchain verified from the last calculated uptime and dividing the result by hundred. Moreover, the processing subsystem includes a validator node selection module (126) operatively coupled with the node utilization module (124) and configured to calculate the plurality of first parameters for each node, randomly select the validator nodes, and add the calculated plurality of first parameters by dividing the plurality of first parameters and a plurality of second parameters by one hundred to get the final score for each node of the plurality of nodes. The validator node selection module (126) is also configured to select a plurality of nodes (114) as the validator nodes base based on the final score at pre-defined time intervals and add a transaction to the selected plurality of nodes (114) upon implementing Byzantine Fault Tolerance.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s).

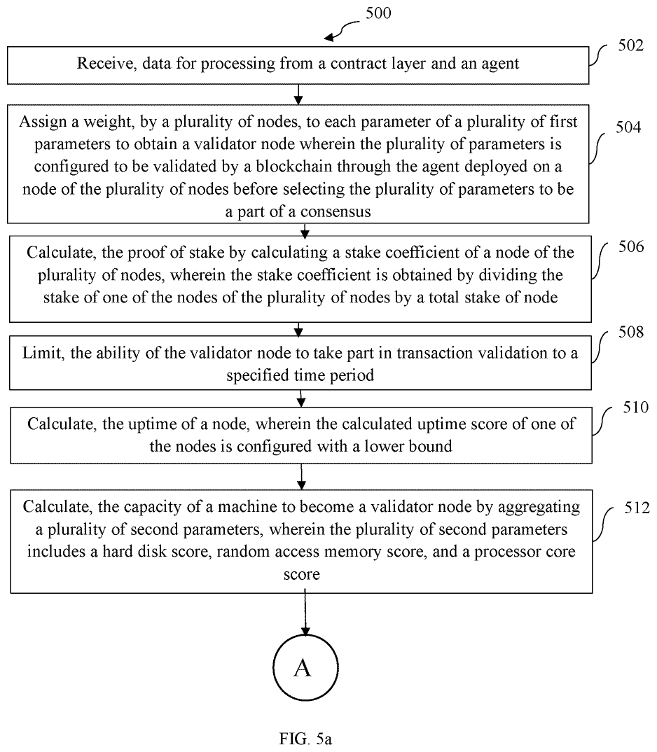

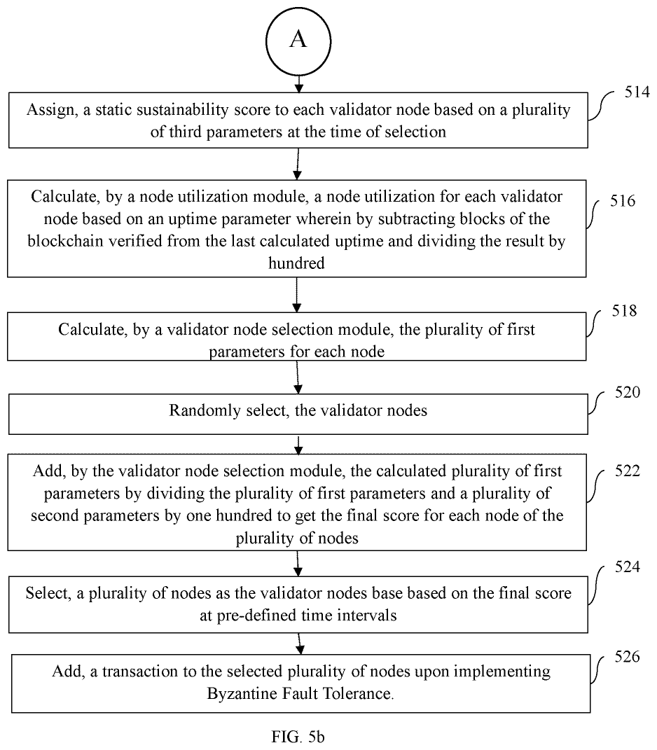

FIG. 5(a) is a flow chart representing the steps involved in a method for consensus mechanism in a block chain network in accordance with an embodiment of the present disclosure. FIG. 5(b) is the continued steps involved in the method for consensus mechanism in accordance with an embodiment of the present disclosure. The method includes receiving, by a receiving module of a processing subsystem, data for processing from a contract layer and an agent in step (502).

The method includes assigning a weight, by a plurality of nodes, to each parameter of a plurality of first parameters to obtain a validator node in step (504). The plurality of parameters is configured to be validated by a blockchain through the agent deployed on a node of the plurality of nodes before selecting the plurality of parameters to be a part of a consensus.

It must be noted that the plurality of parameters are stakes, uptime, capacity, sustainability score and utilization.

In one embodiment, the agent deployed on the node of the plurality of nodes prevents a sybil-attack on the blockchain.

The method includes calculating, by a stake parameter calculation module, the proof of stake by calculating a stake coefficient of a node of the plurality of nodes in step (506). The stake coefficient is obtained by dividing the stake of one of the nodes of the plurality of nodes by a total stake of nodes.

The method includes limiting, by an uptime calculation module, the ability of the validator node to take part in transaction validation to a specified time period in step (508).

The method includes calculating, by the uptime calculation module, the uptime of a node, wherein the calculated uptime score of one of the nodes is configured with a lower bound in step (510). In one embodiment, the uptime calculation module is configured to uptime calculation module is utilized for activities other than transaction validations thereby increasing the efficiency and utilization of the node.

The method includes calculating, by a capacity calculation module, the capacity of a machine to become a validator node by aggregating a plurality of second parameters, wherein the plurality of second parameters includes a hard disk score, random access memory score and a processor core score in step (512).

The method includes assigning, by a sustainability score module, a static sustainability score to each validator node based on a plurality of third parameters at the time of selection in step (514).

The method includes calculating, by a node utilization module, a node utilization for each validator node based on an uptime parameter wherein by subtracting blocks of the blockchain verified from the last calculated uptime and dividing the result by hundred in step (516). In one embodiment, the node utilization is configured to have a lower bound of zero.

The method includes calculating, by a validator node selection module, the plurality of first parameters for each node in step (518). In one embodiment, the validator node selection module is configured to select a top predefined node as the validator node from a predefined pool of validator nodes based on the total score.

In another embodiment, the validator node selection module is configured to randomly select the validator node.

The method includes randomly selecting, by the validator node selection module, the validator nodes in step (520). The selection of validator nodes is based on real time validated data.

The method includes adding, by the validator node selection module, the calculated plurality of first parameters by dividing the plurality of first parameters and a plurality of second parameters by one hundred to get the final score for each node of the plurality of nodes in step (522).

The method includes selecting, by the validator node selection module, a plurality of nodes as the validator nodes base based on the final score at pre-defined time intervals in step (524).

The method includes adding, by the validator node selection module, a transaction to the selected plurality of nodes upon implementing Byzantine Fault Tolerance in step (526).

Various embodiments of the system and method for consensus mechanism in a block chain network described above enable various advantages. The combination of the plurality of parameters (stakes, capacity, uptime, node utilization and sustainability) ensures a high grade of randomization of selecting validator nodes. As a result, cartelization is reduced. Further, the randomization of validator nodes resolves the issue of Sybil attacks along with other vulnerability attacks as well. Further, the consensus mechanism leads to sustainability due to the inclusion of sustainability factors like gender equality, energy consumption and the like, making it fit into the ESG framework. Furthermore, there is a reduced number of vulnerability attacks due to the selection of validator nodes in real time (therefore, the possibility of nodes taking over the network will be minimum).

It will be understood by those skilled in the art that the foregoing general description and the following detailed description are exemplary and explanatory of the disclosure and are not intended to be restrictive thereof. While specific language has been used to describe the disclosure, any limitations arising on account of the same are not intended.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

I claim:

1. A system (100) for a consensus mechanism in a blockchain (130) comprises:
characterized in that:
a processing subsystem (105), hosted on a server (108) and configured to execute on a network (110) to control bidirectional communications among a plurality of modules comprising:
a receiving module (112) configured to receive data for processing from a contract layer and an agent (128);
a plurality of nodes (114) operatively connected to the receiving module (112) and configured to assign a weight to each parameter of a plurality of first parameters to obtain a validator node wherein,
the plurality of parameters is configured to be validated by a blockchain (130) through the agent (128) deployed on a node of the plurality of nodes (114) before selecting the plurality of parameters to be a part of a consensus;
a stake parameter calculation module (116) operatively coupled to the plurality of nodes (114) and configured to calculate the proof of stake by calculating a stake coefficient of a node of the plurality of nodes, wherein the stake coefficient is obtained by dividing the stake of one of the nodes of the plurality of nodes (114) by a total stake of nodes;
an uptime calculation module (118) operatively coupled with the stake parameter calculation module (116) configured to:
limit the ability of the validator node to take part in transaction validation to a specified time period;
calculate the uptime of a node, wherein the calculated uptime score of one of the nodes is configured with a lower bound;
a capacity calculation module (120) operatively coupled with the uptime calculation module (118) and configured to calculate the capacity of a machine to become a validator node by aggregating a plurality of second parameters, wherein the plurality of second parameters includes a hard disk score, random access memory score and a processor core score;
a sustainability score module (122) operatively coupled with the capacity calculation module (120) and configured to assign a static sustainability score to each validator node based on a plurality of third parameters at the time of selection;
a node utilization module (124) operatively coupled with the sustainability score module (122) and configured to calculate a node utilization for each validator node based on an uptime parameter wherein by subtracting blocks of the blockchain (130) verified from the last calculated uptime and dividing the result by hundred;
a validator node selection module (126) operatively coupled with the node utilization module (124) and configured to:
calculate the plurality of first parameters for each node;
randomly select the validator nodes;
add the calculated plurality of first parameters by dividing the plurality of first parameters and a plurality of second parameters by one hundred to get the final score for each node of the plurality of nodes;
select a plurality of nodes (114) as the validator nodes based on the final score at pre-defined time intervals; and
add a transaction to the selected plurality of nodes (114) upon implementing Byzantine Fault Tolerance.

2. The system (100) as claimed in claim 1 wherein the plurality of parameters are stakes, uptime, capacity, sustainability score and utilization.

3. The system (100) as claimed in claim 1, wherein the agent (128) deployed on the node of the plurality of nodes (114) prevents a sybil-attack on the blockchain (130).

4. The system (100) as claimed in claim 1, wherein the uptime calculation module (118) is utilized for activities other than transaction validations thereby increasing the efficiency and utilization of the node.

5. The system as claimed in claim 1, wherein the node utilization is configured to have a lower bound of zero.

6. The system as claimed in claim 1, wherein the validator node selection module (126) is configured to select a top predefined node as the validator node from a predefined pool of validator nodes based on the total score.

7. The system as claimed in claim 1, wherein the selection of validator nodes is based on real time validated data.

8. The system as claimed in claim 1, wherein the validator node selection module (126) is configured to randomly select the validator node.

9. A method (500) for consensus mechanism in a block chain comprising:
characterized in that:
receiving, by a receiving module of a processing subsystem, data for processing from a contract layer and an agent; (502)
assigning a weight, by a plurality of nodes, to each parameter of a plurality of first parameters to obtain a validator node wherein the plurality of parameters is configured to be validated by a blockchain through the agent deployed on a node of the plurality of nodes before selecting the plurality of parameters to be a part of a consensus; (504)
calculating, by a stake parameter calculation module, the proof of stake by calculating a stake coefficient of a node of the plurality of nodes, wherein the stake coefficient is obtained by dividing the stake of one of the nodes of the plurality of nodes by a total stake of nodes; (506)
limiting, by an uptime calculation module, the ability of the validator node to take part in transaction validation to a specified time period; (508)
calculating, by the uptime calculation module, the uptime of a node, wherein the calculated uptime score of one of the nodes is configured with a lower bound; (510)
calculating, by a capacity calculation module, the capacity of a machine to become a validator node by aggregating a plurality of second parameters, wherein the plurality of second parameters includes a hard disk score, random access memory score and a processor core score; (512)
assigning, by a sustainability score module, a static sustainability score to each validator node based on a plurality of third parameters at the time of selection; (514)
calculating, by a node utilization module, a node utilization for each validator node based on an uptime parameter wherein by subtracting blocks of the blockchain verified from the last calculated uptime and dividing the result by hundred; (516)
calculating, by a validator node selection module, the plurality of first parameters for each node; (518)
randomly selecting, by the validator node selection module, the validator nodes; (520)
adding, by the validator node selection module, the calculated plurality of first parameters by dividing the plurality of first parameters and a plurality of second parameters by one hundred to get the final score for each node of the plurality of nodes; (522)
selecting, by the validator node selection module, a plurality of nodes as the validator nodes base based on the final score at pre-defined time intervals; (524) and
adding, by the validator node selection module, a transaction to the selected plurality of nodes upon implementing Byzantine Fault Tolerance. (526)
